(19) United States
(12) Patent Application Publication
(10) Pub. No.: US 2008/0074737 A1
(43) Pub. Date: Mar. 27, 2008

(54) Separated functional layer stack and titanium nitride layer for achieving solar control

(76) Inventors: Yisheng Dai, Santa Clara, CA (US); Yeo Boon Khee, Singapore (SG); Sicco W.T. Westra, Los Altos Hills, CA (US)

Correspondence Address: Terry McHugh;Law Offices of Terry McHugh, 101 First Street, PMB 560, Los Altos, CA, 94022, US

(21) Appl. No.: 11/524,993

(22) Filed: Sep. 21, 2006

(51) Int. Cl. G02B 1/00; C03C 17/02

(52) U.S. Cl. 359/359; 427/160

(57) ABSTRACT

A solar control member for determining solar control for a window includes an optically massive layer between an optically functional layer stack and a titanium nitride layer. The optically massive layer has sufficient thickness to retard or prevent constructive and destructive interference of reflected light. The optically massive layer may be an adhesive, but also may be one or more polymeric substrates. The layer stack may be a Fabry-Perot interference filter. Also in the preferred embodiment, the titanium nitride layer is closer to the window (e.g., glass) than the layer stack.

### TECHNICAL FIELD

The invention relates generally to solar control members and more particularly to providing solar control for a window.

### BACKGROUND ART

The use of films to control the levels of reflection and transmission of a window at different frequency ranges of light is known in the art. For vehicle windows and many windows of buildings and residences, glare is reduced by controlling transmissivity of visible light (T_{VIS}) and reflectivity of visible light (R_{VIS}) at wavelengths between 400 nm and 700 nm. For the same window applications, heat load may be reduced by partially blocking solar transmission (T_{SOL}) in one or both of the visible portion of the solar spectrum and the near infrared (700 nm to 1200 nm) portion.

One known sequence of films for providing solar control is shown in FIG. 1 and is described in U.S. Pat. No. 6,034,813 to Woodard et al., which is assigned to the assignee of the present invention. In FIG. 1, a solar control arrangement of films is attached to a glass substrate 12 by a pressure sensitive adhesive (PSA) 14. Originally, the solar control arrangement is formed on a flexible polyethylene terephthalate (PET) substrate 16. The solar control arrangement includes a Fabry-Perot interference filter 18, an adhesive layer 20, a gray metal layer 22, another PET substrate 24, and a hardcoat layer 26. The second adhesive layer 20 is used when the Fabry-Perot interference filter 18 is formed on one PET substrate 16, while the gray metal layer 22 is formed on the second PET substrate 24.

The Fabry-Perot interference filter 18 provides solar load reduction by preferentially passing light at certain wavelengths and reflecting light at other wavelengths. An example of a Fabry-Perot interference filter is described in U.S. Pat. No. 4,799,745 to Meyer et al. This patent describes a virtually transparent, infrared reflecting Fabry-Perot interference filter that is characterized by transparent metal layers spaced apart by dielectric layers of a metal oxide. The gray metal layer 22 of FIG. 1 contributes to the final optical properties of the arrangement. The Woodard et al. patent states that the gray metal layer is preferably formed of a metal or alloy, such as nickel chromium having a thickness in the range of 2 nm to 20 nm. The gray metal layer should be sufficiently thick to partially block the transmission of visible light through the film.

Another known optical arrangement is described in U.S. Pat. No. 6,707,610 to Woodard et al., which is also assigned to the assignee of the present invention. With reference to FIG. 2, an optical arrangement is shown as being adhered to glass 28 by a PSA 30. For example, the glass may be a windshield of a vehicle or a window of a building or home. The PSA layer 30 is sandwiched between the glass and a first PET substrate 32. On the opposite side of the PET substrate is a slip layer 34. An optical coating of titanium nitride has a thickness selected primarily for achieving desired optical characteristics, such as solar control. A nickel chromium layer 38 is described as being a damage-retardation layer. Rather than nickel chromium, other gray metal materials may be used. Atop the titanium nitride layer 36 is a laminating adhesive 40, a second PET substrate 42, and one or more protective layers 44, such as a hardcoat or anti-scratch layer.

In the design of optical arrangements for windows, optical considerations and structural considerations must be addressed. Tailoring transmissivity and reflectivity on the basis of wavelength provides advantages. For example, it is typically beneficial to have higher reflectivity in the infrared range than in the visible range of the spectrum. Within the visible range, color neutrality is often desired. Color neutrality should not vary with the angle of view and should not change with age. Regarding structural stability, reducing the susceptibility of coatings to cracking during fabrication, installation, or long-term use is an important consideration. During fabrication, films are exposed to high temperatures and pressures. During installation, cracks may develop as a consequence of bending, such as when a flexible coated PET substrate is bent to follow the contour of a windshield. When a coated polymeric substrate having a titanium nitride layer is flexed, the titanium nitride layer has a tendency to crack.

While the prior art approaches operate well for their intended purpose, further advances are sought.

### SUMMARY OF THE INVENTION

A solar control member formed in accordance with the invention includes an optically massive layer between an optically functional layer stack designed to achieve desired optical properties and a titanium nitride layer configured to cooperate with the layer stack to achieve a target solar performance. The solar control member is particularly useful for window applications, such as vehicle windows and windows for residences and buildings.

As used herein, the term “optically massive layer” is defined as a layer that is sufficiently thick to retard or prevent constructive and destructive interference of reflected light. Thus, the optically massive layer is distinguishable (1) from a layer or a layer stack that is optically active and (2) from a layer or a layer stack that is optically passive as a consequence of being thin (such as a slip layer). In one embodiment, the optically massive layer is a substrate, such as a PET substrate. If the optically massive layer is a substrate, any material that may initially reside on a surface of the substrate, such as a slip agent, is preferably removed, such as by using a burn-off process of exposing the substrate to a glow discharge. The titanium nitride layer is a “stand-alone layer” on its side of the optically massive layer, at least with respect to achieving the target optical properties. Alternatively, the optically massive layer is a thick adhesive layer for bonding the titanium nitride layer to the layer stack. The layer stack and titanium nitride layer preferably physically contact the opposite sides of the optically massive layer.

The layer stack is “optically functional,” which is defined herein as a sequence of layers configured to achieve desired properties with respect to wavelength selectivity in transmission and reflection. Preferably, the layer stack is configured to provide solar control. However, the solar performance is further improved by the use of the titanium nitride layer on the opposite side of the optically massive layer. One acceptable layer stack is the one marketed by Southwall Technologies, Inc. under the trademark XIR. The titanium nitride layer provides a means to adjust the transmissivity of visible light (T_{VIS}) for the entire solar control member.

It has been determined that the combination of the titanium nitride layer and the layer stack on opposite sides of the optically passive layer achieves a desirable solar performance when used in window applications.

### BRIEF DESCRIPTION OF THE DRAWINGS

FIG. 1 is a sectional view of an optical member in accordance with the prior art.

FIG. 2 is a sectional view of an optical arrangement in accordance with a second prior art approach.

FIG. 3 is a sectional view of a solar control member attached to glass in accordance with one embodiment of the invention.

FIG. 4 is a sectional view of a second embodiment of the invention.

FIG. 5 is sectional view of a third embodiment of the invention, but prior to application to glass.

FIG. 6 is a fourth embodiment of the invention.

FIG. 7 is one possible functional layer stack for use in one of the embodiments of FIG. 3 or FIG. 4, but is illustrated as being applied to FIG. 3.

FIG. 8 is one possible functional layer stack for use in one of the embodiments of FIG. 5 or FIG. 6, but is illustrated as being applied to FIG. 5.

FIGS. 9-11 are plots of measured optical performances of samples formed to test the benefits of the invention.

### DETAILED DESCRIPTION

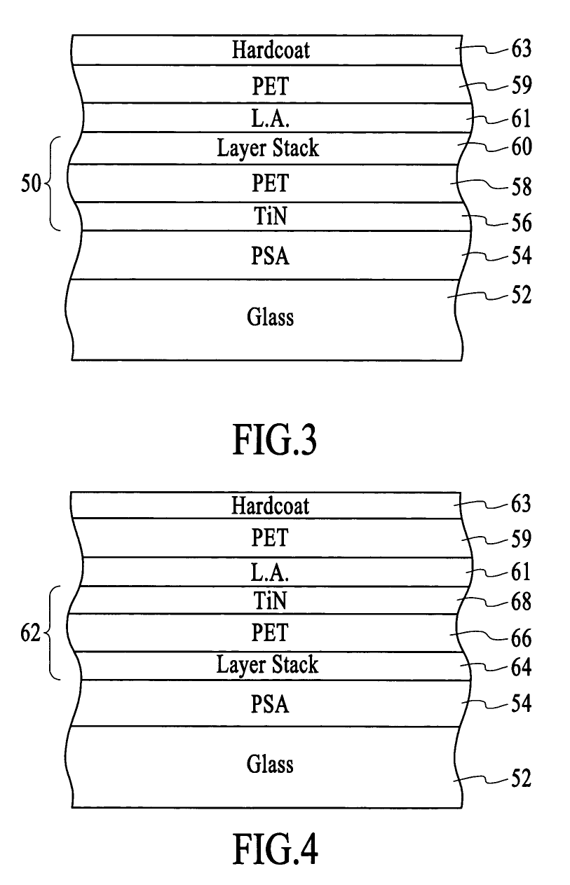

With reference to FIG. 3, a solar control member 50 is shown as being attached to glass 52 by a pressure sensitive adhesive (PSA) 54. In this embodiment, the solar control member is formed of a titanium nitride layer 56, a PET substrate 58, and an optically functional layer stack 60. The PET substrate 58 is sufficiently thick to be an “optically massive layer.” That is, the thickness is such that constructive and destructive interference of reflected light is retarded. The PET substrate should be generally transparent and should have a thickness of at least 25 microns. The thickness of the titanium nitride layer is preferably in the range of 5 nm to 25 nm (and most preferably between 12 nm and 22 nm). The thickness of the laminating adhesive 82 is at least 5 microns. It has been determined that spacing a titanium nitride layer from an optically functional layer stack as shown in FIG. 3 provides superior solar performance when compared to other solar arrangements. Test results will be presented in paragraphs that follow.

In the embodiment of FIG. 3, the titanium nitride layer 56 and the layer stack 60 may be formed on opposite sides of the PET substrate 58, such as by sputter deposition. To protect the layer stack from exposure following subsequent installation to the glass 52, a second PET substrate 59 is attached to the solar control member 50 using a laminating adhesive 61. A protective layer, such as a hardcoat 63, may be added. The “optically functional layer stack” is defined herein as a sequence of layers which are cooperative to achieve desired optical properties for solar control. As one preferred embodiment, the layer stack may be a sequence of layers that forms a Fabry-Perot interference filter. In a more preferred embodiment, the layer stack is a solar control arrangement sold by Southwall Technologies, Inc. under the trademark XIR.

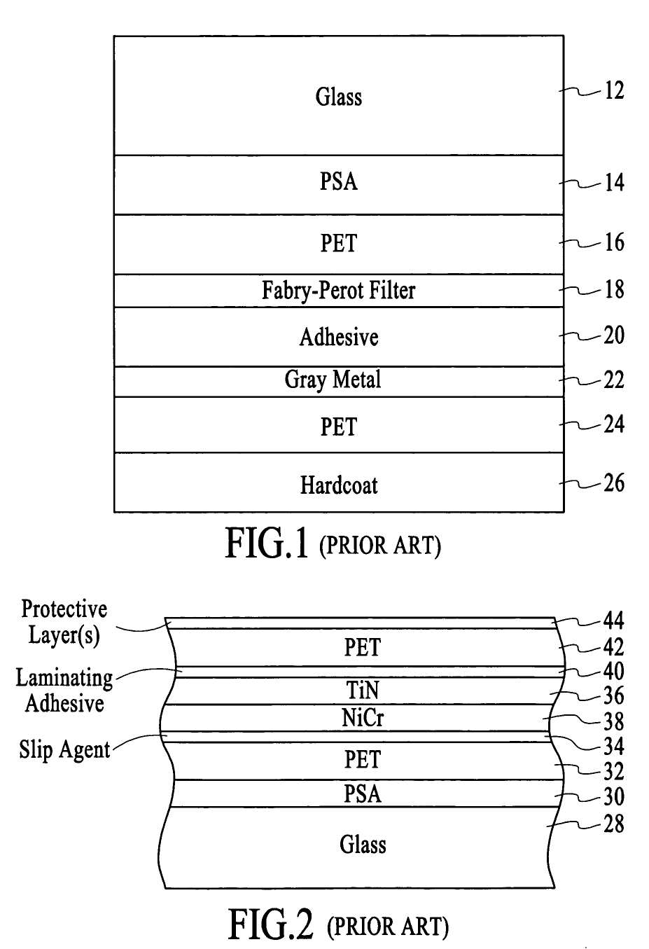

A second embodiment of the invention is shown in FIG. 4. The solar control member 62 of this embodiment is similar to that of FIG. 3, but the layer stack 64 of FIG. 4 is adjacent to the glass 52, while the titanium nitride layer 68 is the outermost layer within the solar control member. The “supporting layers” 54, 59, 61 and 63 are shown as being identical to those of FIG. 3. While test results show that the embodiment of FIG. 3 is preferred to that of FIG. 4, both embodiments have advantages as compared to prior art approaches, such as the ones shown in FIGS. 1 and 2.

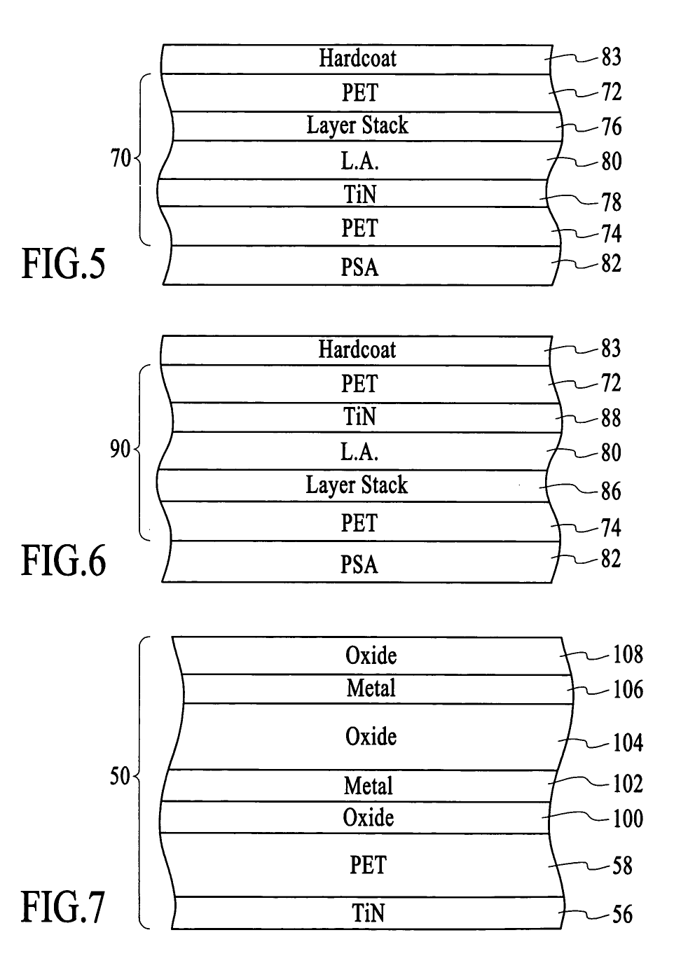

In FIG. 5, a solar control member 70 is shown as including a pair of PET substrates 72 and 74. The optically functional layer stack 76 may be initially sputtered on the PET substrate 72, with the titanium nitride layer 78 being sputtered onto the PET substrate 74 in a separate process. Then, an optically massive laminating adhesive layer 80 may be used to attach the two layers and their respective PET substrates. Simultaneously, the laminating adhesive layer 80 provides the desired physical and optical relationships between the layer stack and the titanium nitride layer. A PSA layer 82 is included for attaching the solar control member to glass. On the opposite side, a hardcoat layer 83 is applied to protect the exposed surface of the solar control member 70.

Solar control member 90 of FIG. 6 is similar to that of FIG. 5, but the positions of the optically functional layer stack 86 and the titanium nitride layer 88 are reversed. Thus, the layer stack will be closer to glass when the PSA 82 is used to attach the solar control member to glass. As in FIG. 5, a hardcoat layer 83 provides protection to the exposed surface.

As described with reference to the embodiments of FIGS. 3 and 4, the optically massive layer may be a polymer substrate, such as the PET substrates 58 and 66. On the other hand, FIGS. 5 and 6 illustrate embodiments in which the optically massive layer that separates the layer stack from the titanium nitride layer is an adhesive layer. While not shown in the drawings, a third alternative would be one in which the optically massive layer is a combination of substrate material and adhesive material. For example, if the two PET substrates 72 and 74 are attached directly by an adhesive, so that the layer stack and the titanium nitride layer 76 and 78 sandwich the substrates and the adhesive, then the “optically massive layer” will comprise the two substrates and the adhesive. In such an embodiment, the layer stack or titanium nitride layer will be the outermost element, so that it would be necessary to provide protection against exposure. Such protection may be provided using the laminated PET substrate 59 and hardcoat layer 63 shown in the embodiments of FIGS. 3 and 4.

The solar control members 50, 62, 70 and 90 of FIGS. 3-6 may be attached to vehicle windows, as well as business or residential windows. While the windows will be described as being glass, the invention may be used with other types of transparent substrates that are used to form windows.

A key improvement in each of the solar control members illustrated in FIGS. 3-6 relates to the use of the optically massive layer between the titanium nitride layer and the optically functional layer stack. Particularly if the optically massive layer is a laminating adhesive, this layer serves the function of a “shock absorber” to absorb a portion of the mechanical energy that may be impacted on the solar control member. Such mechanical energy may be the result of installation and heat shrinking of the solar control member onto glass 52, as shown in FIGS. 3 and 4. It has also been determined that the structures of the layer stack and the titanium nitride layer of a solar control member in accordance with the invention reduce the susceptibility of the member to cracking and “hide” cracking if it does occur. The effectiveness of “hiding” cracking depends upon the side from which the coated glass is viewed, relative to the source of light. By incorporating the layer stack with the titanium nitride layer, a darker and more spectrally selective solar control member can be achieved as compared to using a single titanium nitride layer or even a dual thick titanium nitride layer, thus reducing the susceptibility to visible cracking (persons skilled in the art will recognize that the gray metal layer will have this effect). By selecting the proper thickness of the titanium nitride layer, cracking can be controlled and a desirable transmissivity and solar performance can be achieved. In one embodiment, the layer stack may be designed to provide the basic desired solar rejection properties. Then, the thickness of the titanium nitride layer is selected to achieve a total transmissivity of light of forty-two percent, while further improving the solar rejection properties.

One possible embodiment of a layer stack is shown in FIG. 7. Merely for purposes of example, the solar control member 50 of FIG. 3 is considered. Thus, the PET substrate 58 is the “optically massive layer” that separates the titanium nitride layer 57 from the layer stack. The various layers may be sputter deposited on the different sides of the PET substrate. In the illustrated embodiment, the layer stack forms a Fabry-Perot interference filter, which is often referred to generally as a solar-load-reduction (SLR) film. The Fabry-Perot filter selectively excludes a substantial portion of infrared wavelength radiation, while transmitting a substantial portion of visible light. In the Fabry-Perot filter of FIG. 7, the layers are not shown to scale. Possible materials and thicknesses may be: a first continuous indium oxide dielectric film 100 having a thickness in the range of 15-60 nm; a first continuous electrically conductive silver metal film 102 having a thickness in the range of 4-25 nm; a second continuous indium oxide dielectric film 104 having a thickness in the range of 30-120 nm; a second continuous silver metal film 106 having a thickness in the range of 4-25 nm; and a third continuous indium oxide dielectric film 108 having a thickness in the range of 15-60 nm. Additional layers may be provided, such as a third continuous silver metal layer and a fourth continuous indium oxide dielectric film.

The same approach to providing an optically functional layer stack is shown in FIG. 8, but as applied to the solar control member 70 of FIG. 5. Here, the optically massive layer is the laminating adhesive layer 80 that separates the titanium nitride layer 56 from the layer stack. The layer stack may be formed on the upper PET substrate 72, while the titanium nitride layer may be formed on the lower PET substrate 74, as viewed in FIG. 8. The various layers of the stack may be sputter deposited. In the embodiment shown in FIG. 8, the layer stack forms a Fabry-Perot filter, in the same manner described with reference to FIG. 7, so that the same reference numerals are applied to the individual layers 100, 102, 104, 106 and 108.

A number of samples were fabricated and tested in order to determine the advantages of the invention. In Table 1, ten samples are shown, with the optical measurements for a different sample being listed in ten columns of the table.

TABLE 1

| | V70T51 | V70T35 | V75T51 | V75T35 | T51V70 | T35V70 | T51V75 | T35V75 | ref A | ref B |
|---|---|---|---|---|---|---|---|---|---|---|
| T_{VIS} | 39.50 | 27.46 | 43.97 | 30.25 | 39.84 | 27.66 | 42.62 | 30.54 | 42.75 | 31.62 |
| R_{VIS} | 12.31 | 15.54 | 13.19 | 16.63 | 10.26 | 14.85 | 10.79 | 17.75 | 8.92 | 10.84 |
| T_{SOL} | 18.25 | 12.39 | 24.89 | 16.28 | 18.45 | 12.58 | 24.34 | 16.45 | 31.19 | 20.92 |
| R_{SOL} | 33.30 | 34.57 | 26.92 | 29.21 | 16.03 | 21.07 | 15.05 | 22.47 | 10.03 | 13.69 |
| A_{SOL} | 48.44 | 53.03 | 48.18 | 54.50 | 65.51 | 66.35 | 60.60 | 61.07 | 58.78 | 65.39 |
| SR | 0.69 | 0.73 | 0.62 | 0.69 | 0.64 | 0.70 | 0.59 | 0.67 | 0.53 | 0.61 |
| SC | 0.36 | 0.34 | 0.44 | 0.36 | 0.42 | 0.35 | 0.47 | 0.38 | 0.55 | 0.45 |
| T₉₈₀ | 3.43 | 2.08 | 13.10 | 7.57 | 3.61 | 2.20 | 12.89 | 7.64 | 26.40 | 14.30 |

The first four samples represent the embodiment shown in FIG. 5, which includes the titanium nitride layer 78 closer to the glass than the layer stack 76. In each of these samples, the letter “T” represents titanium nitride, the letter “V” represents the optically functional layer stack, and the subsequent number represents the transmissivity of the individual layer or layer stack. In the next four samples, the embodiment of FIG. 6 is represented, since the layer stack 86 is closer to the glass than the titanium nitride layer 88 (i.e., the layer stack “V” is identified before the titanium nitride “T”). The uses of the letters “T” and “V” and the use of the numbers are consistent with the uses for the first four samples. The final two samples are for purposes of evaluation, since they do not represent the invention. The two samples ref A and ref B are, respectively, (1) a pair of titanium nitride layers with nominal T_{VIS} of 59 percent each, and (2) a pair of titanium nitride layers with nominal T_{VIS} of 51 percent each.

In Table 1, T_{VIS} is the transmissivity of visible light, while R_{VIS} is the reflectance within the visible light portion of the light spectrum. Reflectance parameters are measured from the glass side of the sample. T_{SOL} is solar transmissivity and R_{SOL} is solar reflectivity. ASOL is a measure of the solar absorptivity. Transmissivity at the wavelength 980 nm was also measured (T₉₈₀).

In Table 1, “SC” is the shading coefficient, which refers to the fraction of total solar energy entering an environment which is exposed to solar radiation through an opening having a given area, as compared to the fraction obtained through the same area fitted with a 3.2 mm single pane clear glass (ASHRAE standard calculation method). Finally, “SR” refers to solar rejection and will be discussed below.

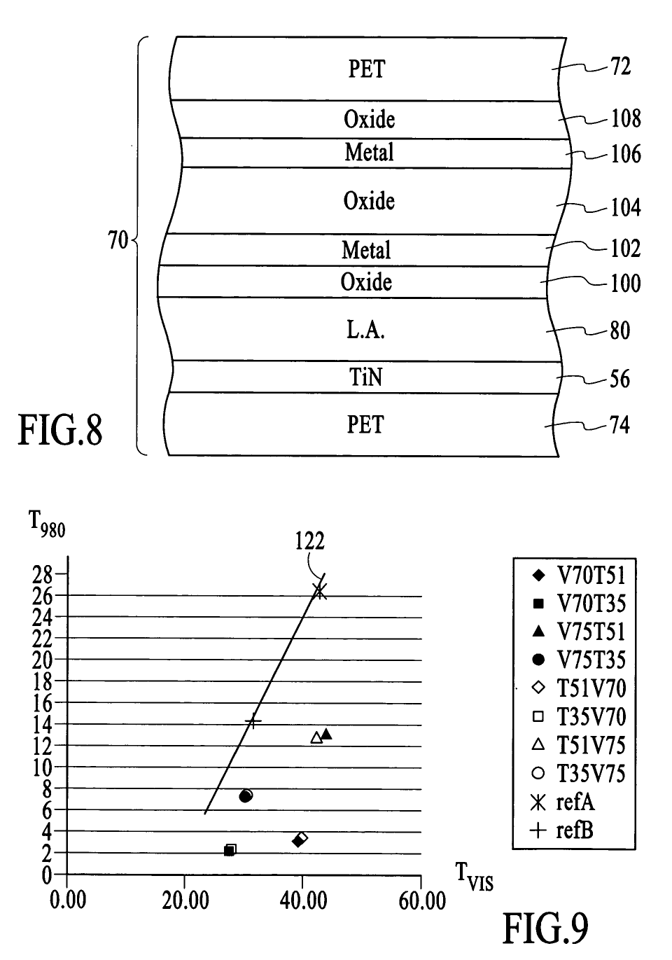

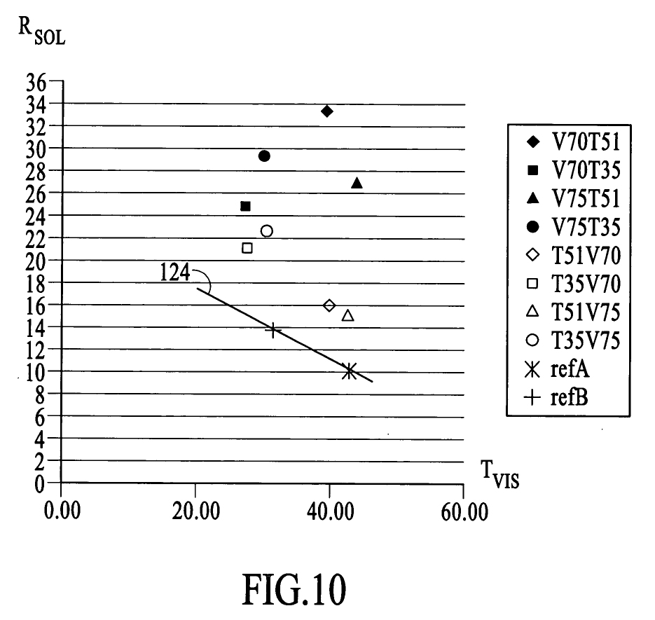

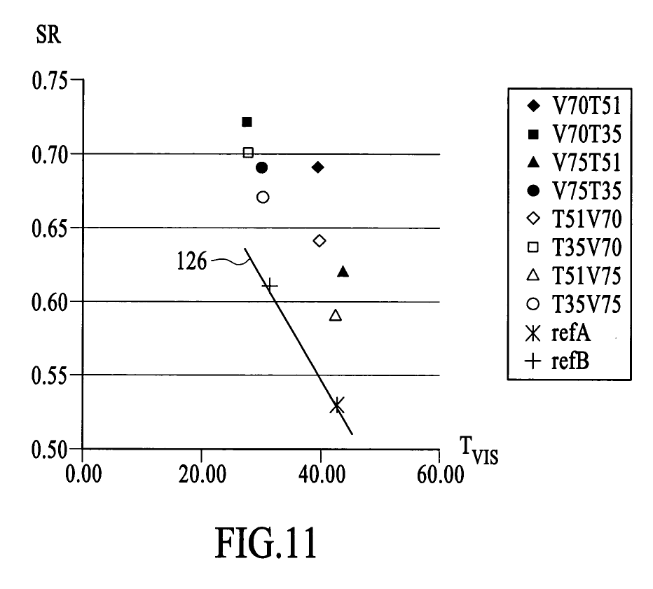

FIGS. 9, 10 and 11 plot some of the relationships from Table 1. In FIG. 9, a line 122 connects the two plots for the dual titanium nitride samples (ref A and ref B) with respect to the ratio of T_{VIS} to T₉₈₀, and all of the plots for the samples in accordance with the invention show superior performance. In FIGS. 10 and 11, solar reflectance and solar rejection values, respectively, are plotted as a function of T_{VIS}. Again, the values for the eight samples in accordance with the invention are all on a preferred side of a line 124 and 126 connecting the two plots for the other two samples.

Because of the ability of XIR to block light within the infrared frequencies, the combinations of XIR with either T51 or T35 exhibit much desired lower transmissions at 980 nm (T₉₈₀), than the two reference samples of double titanium nitride films ref A and ref B.

As compared to the double titanium nitride layers of either ref A or ref B, the different embodiments of the invention exhibited significant improvements with respect to solar rejection and solar reflection. Since the goal is to maximize this improvement, the XIR layer stack should be used as the element closer to the glass relative to the titanium nitride layer.

From FIG. 10, it is clear that solar energy reflection (R_{SOL}) of the eight samples related to the invention is significantly higher than the two reference samples formed of the double titanium nitride. This is particularly true when the optically functional stack layers are located close to the glass.

As applied to glazing, solar rejection (SR) is a performance parameter that is indicative of the total solar energy rejected by the glazing system. This performance parameter is the sum of two aspects of rejected solar energy, namely reflected radiation energy and the solar energy absorbed by the glazing system. Since a portion of the absorbed solar energy is re-radiated from the heated glass surface, only a fraction of the absorbed solar energy contributes to SR. In an inexact estimate, the solar energy is calculated from the equation: SR=R_{SOL} (solar energy reflection)+0.73*A_{SOL} (solar energy absorption). A high SR value is desirable for a solar control member, since a higher SR value indicates that more energy is being blocked from passing through glass to the interior of a vehicle, a building or a residence. As shown in FIG. 11, the solar rejection values of samples configured in accordance with the invention at any given T_{VIS} are significantly higher than the two reference samples by more than 0.6. A relative improvement of greater than ten percent is achieved. This high solar energy rejection is mainly caused by the high solar reflection of the eight samples formed in accordance with the invention, which represents the desired energy rejection format in window film applications.

Another advantage of the invention is the possibility of “hiding” any cracking of the titanium nitride layer by the addition of the XIR or other optically functional layer stack, so as to buffer the reflectance and visible cracks of the titanium nitride layer. The effectiveness of the “hiding” is dependent upon the side of the glass that is viewed relative to a source of illumination.

What is claimed is:

1. A solar control member comprising:
an optically functional layer stack that is generally transparent with respect to visible light and that has a wavelength selectivity for solar control;
an optically massive layer, said optically functional layer stack being on a first side of said optically massive layer; and
a titanium nitride layer on a second side of said optically massive layer opposite to said optically functional layer stack, said titanium nitride layer being configured to cooperate with said optically functional layer stack for solar selectivity.

2. The solar control member of claim 1 wherein said titanium nitride layer is the only layer on said second side which is specifically included to achieve desired optical properties.

3. The solar control member of claim 1 wherein said optically functional layer stack has a transmissivity to visible light that is at least seventy percent and has a solar heat gain coefficient that is less than 0.50.

4. The solar control member of claim 1 wherein said optically massive layer is a generally transparent adhesive layer.

5. The solar control member of claim 1 wherein said optically massive layer is a generally transparent polymeric substrate.

6. The solar control member of claim 1 wherein said optically massive layer is a combination of a generally transparent adhesive and a generally transparent substrate.

7. The solar control member of claim 1 wherein said optically massive layer is a combination of (a) a generally transparent first polymeric substrate on which said optically functional layer stack is fabricated, (b) a generally transparent second polymeric substrate on which said titanium nitride layer is fabricated, and (c) a generally transparent adhesive that adheres said first polymeric substrate to said second polymeric substrate.

8. The solar control member of claim 1 wherein said optically functional layer stack is a solar control stack sold by Southwall Technologies Inc. under the trademark XIR.

9. A method of providing a solar control member comprising:
forming an optically functional layer stack on a first side of an optically massive layer, including selecting and configuring said optically functional layer stack to achieve target optical properties at said first side; and
increasing solar rejection while retaining control over visible cracking by forming a titanium nitride layer on a side of said optically massive layer opposite to said first side.

10. The method of claim 9 wherein forming said titanium nitride layer includes limiting said titanium nitride layer to being the only solar control layer on said second side of said optically massive layer.

11. The method of claim 9 wherein forming said optically functional layer stack includes defining a Fabry-Perot filter.

12. The method of claim 9 wherein forming said optically functional layer stack and forming said titanium nitride layer include providing said formations on opposite sides of a transparent polymeric substrate.

13. The method of claim 9 wherein forming said optically functional layer stack and forming said titanium nitride layer include using an adhesive as said optically massive layer, so as to directly adhere said optically functional layer stack and said titanium nitride layer at said first and second sides.

14. The method of claim 9 wherein forming said optically functional layer stack and forming said titanium nitride layer include depositing said optically functional layer stack and titanium nitride layer on different transparent polymeric substrates and bonding said polymeric substrates together to form said optically massive layer.

15. The method of claim 9 further comprising configuring said solar control member for attachment to a window.

16. A solar control member consisting essentially of:
a transparent substrate;
an optical coating on a first side of said transparent substrate, said optical coating including a Fabry-Perot filter layer; and
a titanium-nitride layer on a second side of said transparent substrate.

17. The solar control member of claim 16 wherein said transparent substrate is a flexible polymeric substrate.
